(19) United States
(12) Patent Application Publication
(10) Pub. No.: US 2010/0173636 A1
(43) Pub. Date: Jul. 8, 2010

(54) Method for improving frequency reuse utilizing synchronized downlink resources from adjacent cells

(76) Inventor: Mingshen Gao, Batavia, IL (US)

Correspondence Address: Alcatel-Lucent, Docket Administrator, Room 2F-192, 600-700 Mountain Ave., Murray Hill, NJ, 07974-0636, US

(21) Appl. No.: 12/319,434

(22) Filed: Jan. 6, 2009

(51) Int. Cl. H04W 28/00

(52) U.S. Cl. 455/447

(57) ABSTRACT

The present invention provides a method for improving frequency reuse utilizing synchronized downlink resources from adjacent cells. The communication system determines that a mobile unit is receiving signals from a first cell and one or more adjacent cells. Upon receiving the data from the EPC to be sent to the mobile unit, the data is also sent to the adjacent cells from the serving cell via the X2-interface by embedding SYNC information into the GTP-U for carrying the PDUs if the adjacent cells are hosted by different eNodeBs. The first cell and adjacent cells allocate identical downlink resource blocks. The first cell and adjacent cells concurrently transmit the data to be received by user equipment within the communication system.

### FIELD OF THE INVENTION

The present invention relates generally to communication systems, and more particularly to frequency reuse in digital communication systems.

### BACKGROUND OF THE INVENTION

LTE/E-UTRA (Long Term Evolution/Evolved UMTS Terrestrial Radio Access) systems use the Orthogonal Frequency Division Multiplexing (OFDM)-based radio access technology for downlink transmissions. Unlike CDMA-based downlink transmissions, where neighboring cells/sectors are assigned with different codes so that the entire frequency is reused in all cells/sectors, the OFDM-based downlink transmissions suffer the reduction of frequency reuse due to the issue of inter-cell interference. Therefore, overall system performance in terms of spectral efficiency and the achieved data rate at the cell edges is greatly reduced.

FIG. 1 depicts a portion 100 of a communication system in accordance with the prior art. Portion 100 includes a plurality of cells or sectors, only three of which (sectors 101-103) are depicted for clarity. Sectors can also be referred to as cells, even when they are parts of the same base station. As depicted in FIG. 1, sectors 101-103 are deployed to use the same frequency to achieve a frequency reuse factor (FRF) of 1. One problem with this solution is the interference from adjacent cells such that, although the FRF=1 can be achieved for CDMA-based radio access, OFDM-based radio access would not be able to achieve the same FRF in practice.

Note, in LTE/E-UTRA, all cells are using the same frequency, but the entire frequency is divided into small pieces called sub-carriers. Twelve consecutive sub-carriers during one time slot correspond to one downlink resource block. FIG. 1 shows that all sub-carriers are reused across all the sectors, meaning that all frequency are reused for all sectors in the system. However, sub-carriers or resource blocks are typically prioritized and operate at different power levels for avoiding interference between adjacent cells/sectors. This interference makes frequency reuse extremely difficult to impossible in practice. In order to deal with this, current communication systems have tried two practical deployments methods: dividing up the spectrum resources or adding “soft frequency reuse” to the divided spectrum.

A second method of dealing with frequency reuse issues is depicted in FIG. 2. FIG. 2 shows a specific set of sub-carriers that are used for a sector, meaning that frequencies are partially reused for the system. In the exemplary embodiment depicted in FIG. 2, portion 200 of a communication system comprises three sectors, sectors 201-203. Sectors 201-203 are deployed with different frequencies, frequencies f1, f2, and f3 respectively, such that each cell uses only part of the total available sub-carriers. Frequencies f1, f2, and f3 are subsets of the total available frequency F such that F=f1+f2+f3. In this configuration, only one-third of the frequency can be used in each sector. Therefore, cell sectors 201-203 have a frequency reuse factor (FRF) of 3.

One proposal for solving the frequency reuse issue is the so called “soft frequency reuse” as shown in FIG. 3. This exemplary embodiment is similar to the configuration depicted in FIG. 2. In this exemplary embodiment, sub-carries are allocated in the same way as in FIG. 2 for users located away from the intersection of sectors 301-303, but users near the intersection of sectors 301-303, such as those near the transmission tower or center of the enodeB's coverage, depicted by shaded area 304, are able to use all the sub-carriers, no matter which sector the users are located in.

When a user is limited to a fraction of the total available sub-carriers, the data rate the user obtains is much lower than the advertised data rate of the system.

In addition, due to the interference effect, the modulation used for the transmission at the edge of a cell will be lower than modulation used at the cell's center, which will reduce the actual data rate even further for the users at the edge of a cell. Therefore, the spectrum efficiency, and consequently the performance of the overall system, is reduced without a solution for the frequency reuse problem in OFDM-based radio access.

This problem will be more pronounced for service providers utilizing the newly auctioned 700 MHz spectrum. Electronic signals at this lower frequency travel farther with better penetration than at the higher frequency. This allows service providers to provide better coverage while utilizing fewer base stations. However, in a densely populated area, it is the capacity, not the coverage, that determines the location of base stations. To provide enough capacity for all the users in the coverage area, the distance between base stations will have to be limited.

This means that the effectiveness of the soft frequency reuse shown in FIG. 3 will be impacted greatly at lower frequencies. Accordingly, area 304, which can make use of the full sub-carriers, will be reduced significantly or may even be completely eliminated. This in turn will make it much less useful for achieving better frequency reuse.

FIG. 4 depicts two cells, cells 411 and 412, and two base stations, base stations 421 and 422, that use half of the available sub-carriers in accordance with the prior art. UE 401 and UE 402 are served by two adjacent base stations, base station 411 and base station 412 respectively, when they are near the edges of cells 411 and 412. UE 401 gets its allocated downlink resource blocks 431 from cell 411 and UE 402 gets its allocated downlink resource blocks 432 from cell 412.

FIG. 5 depicts resource blocks 431 and 432 in accordance with the prior art. Due to inter-cell interference, each UE can only use at most half of the available sub-carriers in this example. In accordance with the prior art, UE 401 receives resource block 431 from base station 421, but base station 421 only utilizes the bottom half of the frequencies, as indicated by the shading of all time periods of frequencies f₂ and f₃. Similarly, UE 402 receives resource block 432 from base station 422, but base station 422 only utilizes the top half of the frequencies, as indicated by the shading of all time periods of frequencies f₀ and f₁.

Therefore, a need exists for a method of maximizing the efficiency of frequencies in digital communication systems while minimizing the effects of interference from adjacent cells.

### BRIEF SUMMARY OF THE INVENTION

The present invention provides a solution to the problems associated with the prior art. In accordance with an exemplary embodiment of the present invention, downlink resource blocks allocated for transmission to a user equipment (commonly referred to as a mobile unit) from multiple base stations are synchronized. In accordance with an exemplary embodiment, the base stations use the upper half of the sub-carriers for transmitting to a first mobile unit and the lower half of the sub-carriers for transmitting to a second mobile unit. This allows the base stations to reuse all frequencies, otherwise known as sub-carriers.

In accordance with the exemplary embodiment, both mobile stations combine the OFDM signals from both base stations. Therefore the actual signal strength received by both mobile units is significantly improved due to the better signal-to-noise ratio (SNR) improvement, because signals from both base stations are exactly the same. Because they are identical, they can be combined by the receiving mobile unit. When two similar signals are added together, the power received by the UEs is quadrupled such that much better data reception can be achieved. Due to this much better data reception, the actual data rate can be increased as a higher level of modulation or higher coding rate can be used. Utilizing this exemplary embodiment, data rates for both mobile units are increased significantly with less usage of downlink resource blocks.

By utilizing this exemplary embodiment, the overall system performance is significantly improved. In prior art systems, two mobile units use up all the resources. Conversely, in the exemplary embodiment of the present invention, additional mobile units can be served with the same amount of resources as the two mobile units in the prior art.

A communication system in accordance with an exemplary embodiment of the present invention comprises user equipment (also known as a mobile unit), a serving base station, a helping base station, and an EPC. The EPC preferably comprises an MME and an S/P Gateway. The EPC is connected to the serving base station via a first link. The first link preferably utilizes an S1 interface.

The synchronization between the serving base station and the helping base station for downlink resource blocks is a second link. The second link is preferably an X2-interface. The serving base station preferably utilizes the SYNC protocol that is introduced as part of the GTP-U in supporting eMBMS services. The GTP-U is the protocol used on top of UDP/IP (IP transport) for carrying user plane protocol data units (PDUs). The SYNC information added to GTP-U is utilized to synchronize data used to generate a certain radio frames. The SYNC protocol provides information related to transmission timing and means to detect and recover packet loss.

In accordance with an exemplary embodiment, one radio frame has ten sub-frames and each sub-frames has two slots. The serving base station sends the user plane PDUs to the helping base station. The helping base station buffers the packets and waits for the transmission timing indicated by the SYNC protocol.

Utilizing this exemplary embodiment, the UE receives identical signals from both the serving and the helping base station and combines the signals.

In one exemplary embodiment of the present invention, the MCH (multicast channel) is used as the transport channel. The serving base station schedules the MCH and the MCH is mapped to the PMCH (physical multicast channels) that utilizes the radio frames specified.

The present invention thereby improves fractional frequency reuse by coordination transmission between adjacent cells. For example, if a downlink resource block is allocated for a UE at the edge of the cell, this would mean that the UE is also close to the corresponding adjacent cell and the downlink resource block shall not be used by the adjacent cell for at least the UEs that are also located in the impacted area.

In addition, the present invention also requests that the adjacent cell transmits the same PDUs synchronously, by using the identical downlink resource blocks for a mobile unit in this situation. The resource blocks comprise the same sub-carriers and the same time slots. This strengthens the signals received by the mobile units as they will be able to combine the OFDM signals from the adjacent cells to improve the actual data reception, because interference is eliminated and SNR is greatly improved, such that much higher data rate can be achieved.

### BRIEF DESCRIPTION OF THE SEVERAL VIEWS OF THE DRAWINGS

FIG. 1 depicts a portion of a communication system using a single frequency for transmission in accordance with the prior art.

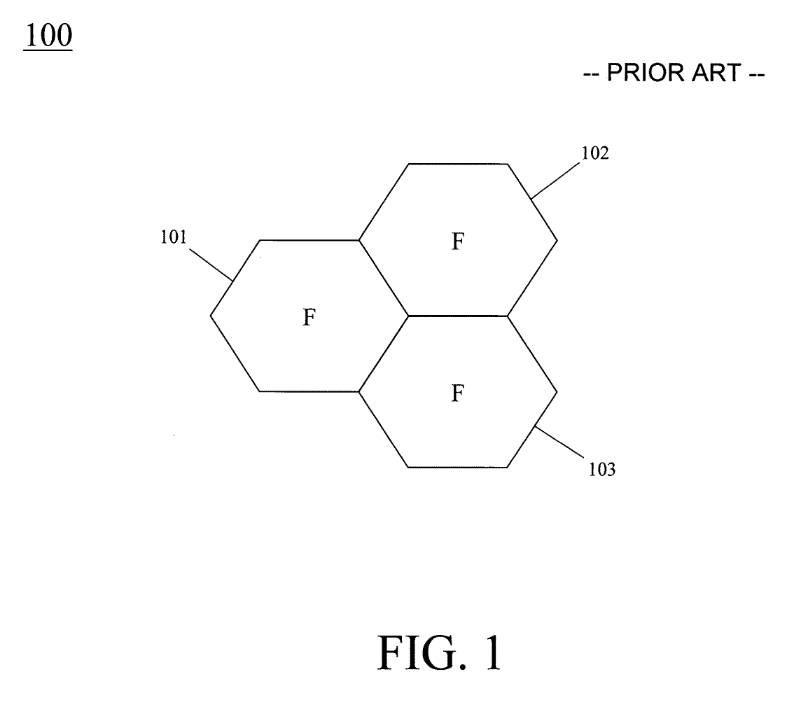

FIG. 2 depicts a portion of a communication system using subsets of the total available sub-carriers in accordance with the prior art.

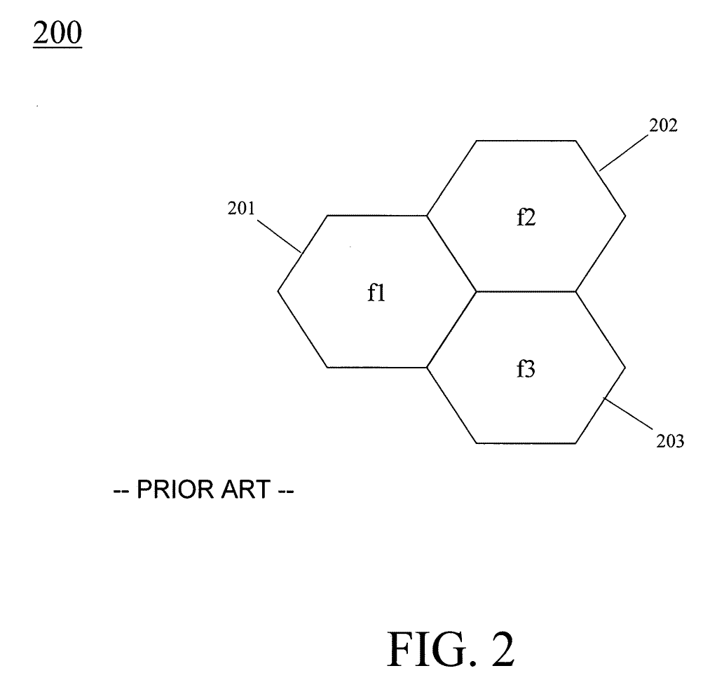

FIG. 3 depicts a portion of a communication system using subsets of sub-carriers near the edge of cells and a single frequency near the eNB transmitting tower in accordance with the prior art.

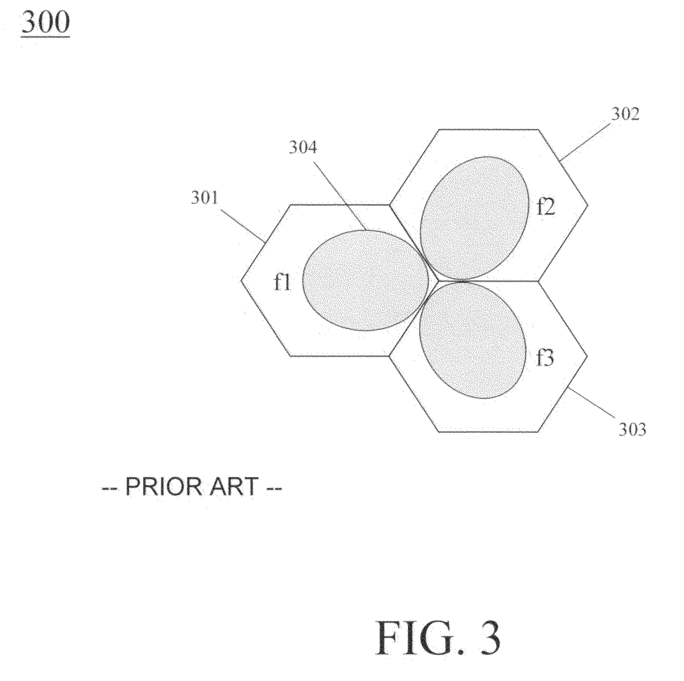

FIG. 4 depicts two adjacent cells from two base stations, each cell using half of the available sub-carriers in accordance with the prior art.

FIG. 5 depicts resource blocks in accordance with the prior art.

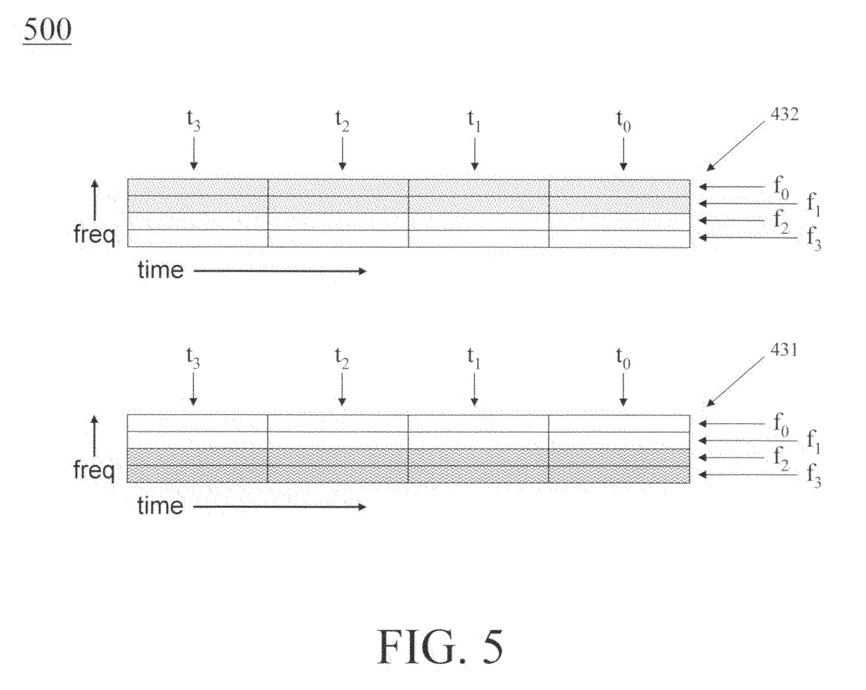

FIG. 6 depicts two cells and two base stations using all sub-carriers in accordance with an exemplary embodiment of the present invention.

FIG. 7 depicts resource blocks in accordance with an exemplary embodiment of the present invention.

FIG. 8 depicts data communications between elements in a communication system in accordance with an exemplary embodiment of the present invention.

### DETAILED DESCRIPTION OF THE INVENTION

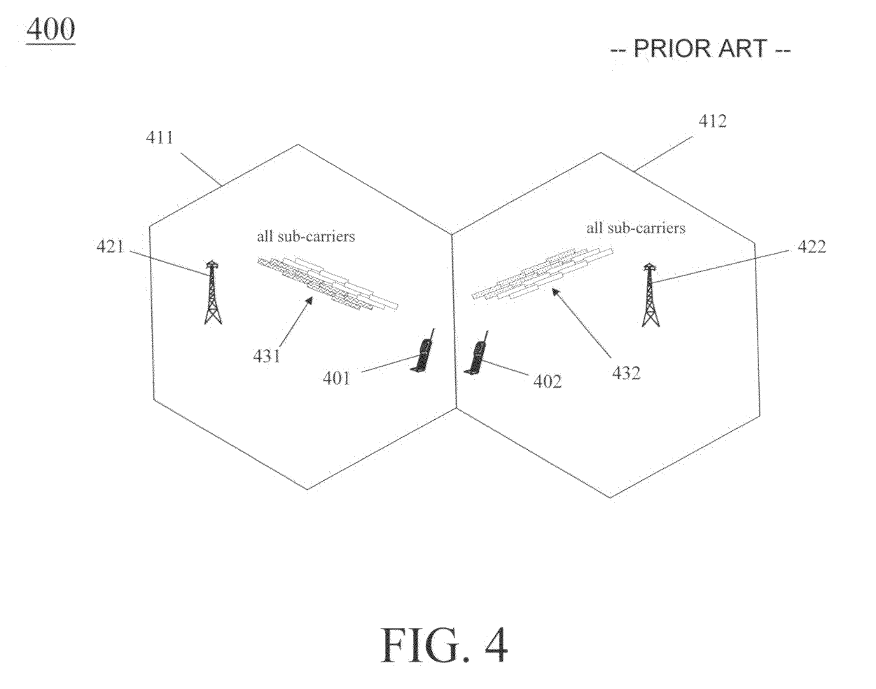

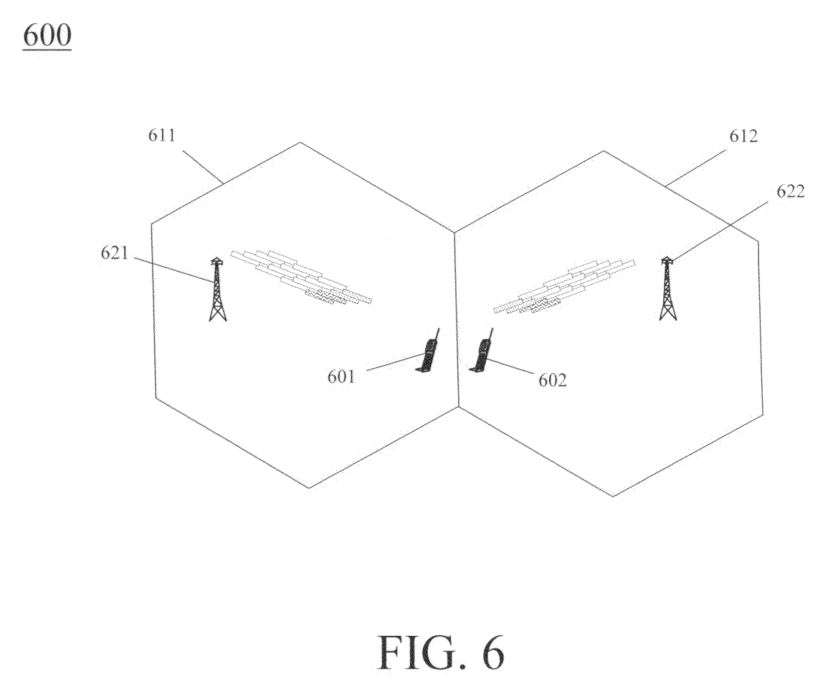

The present invention can be better understood with reference to FIGS. 6 through 8. FIG. 6 shows UE 601 and UE 602 in a similar situation to those in FIG. 4, except that an exemplary embodiment of the present invention is utilized for synchronizing the downlink resource blocks allocated for the UEs. In this exemplary embodiment, base stations 621 and 622 use the upper half of the sub-carriers for transmitting to UE 601 and the lower half of the sub-carriers for transmitting to UE 602. In the exemplary embodiment depicted in FIG. 6, base stations 621 and 622 have reused all the frequencies, otherwise known as sub-carriers. The sub-carriers can also be considered as resource blocks defined for LTE/E-UTRAN. It should be understood that, although only four sub-carriers are show in this exemplary embodiment, in an actual deployment an eNodeB would typically have more than four sub-carriers. In an exemplary embodiment, only part or a whole set of sub-carriers could be used for serving a UE.

In accordance with the exemplary embodiment depicted in FIG. 6, both UE 601 and UE 602 combine the OFDM signals from both base stations, base station 621 and base station 622. Therefore the actual signal strength received by both UE 601 and UE 602 is significantly improved due to the better signal-to-noise ratio (SNR) improvement, because signals from base station 621 and base station 622 are exactly the same for UE 601 and UE 602. Due to this much better signal or data reception, the actual data rate can be increased as a higher level of modulation or higher coding rate can be used. Utilizing this exemplary embodiment, data rates for both UE 601 and UE 602 are increased significantly with less usage of downlink resource blocks.

By utilizing this exemplary embodiment, the overall system performance is significantly improved. With the existing method depicted in FIG. 4, the two UEs use up all the resources, i.e., the four available sub-carriers or four resource blocks for the four time-slots. Conversely, in the exemplary embodiment depicted in FIG. 6, six additional UEs can be served with the same amount of resources as the two UEs depicted in FIG. 4. It should be understood that a communication system would include more resources than this example, but the significance of the present invention can be understood using this simplified scenario.

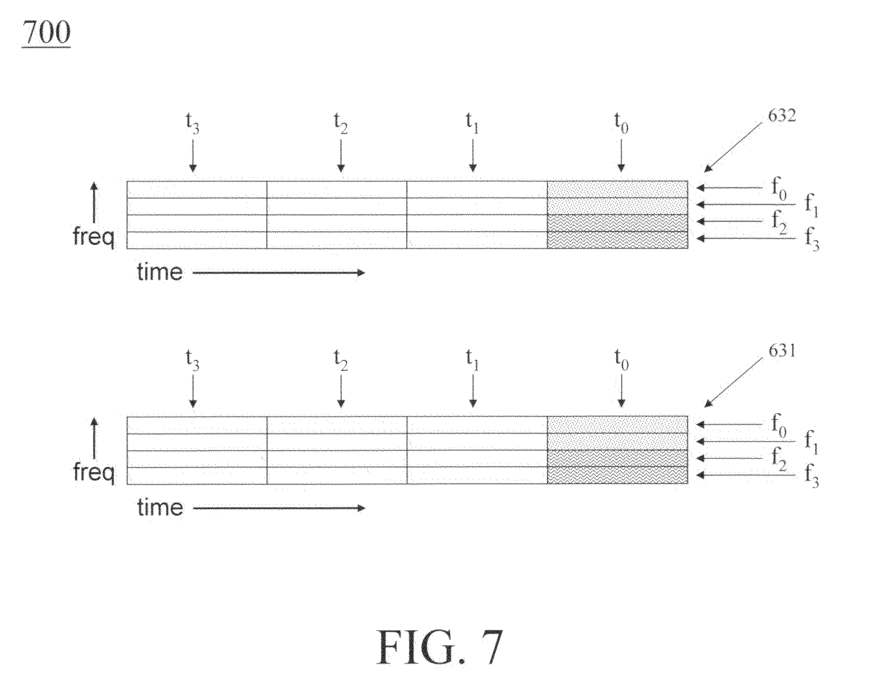

FIG. 7 depicts resource blocks 631 and 632 in accordance with an exemplary embodiment of the present invention. Resource block 631 is transmitted by base station 621 and resource block 632 is transmitted by base station 622. Resource blocks 631 and 632 includes data for both mobile unit 601 and mobile unit 602. In accordance with this exemplary embodiment, resource block 631 includes data for mobile unit 601 in time slot t₀ at frequencies f₀ and f₁ and includes data for mobile unit 602 in time slot t₀ at frequencies f₂ and f₃. Similarly, resource block 632, transmitted by base station 622, includes data for mobile unit 601 in time slot t₀ at frequencies f₀ and f₁ and includes data for mobile unit 602 in time slot t₀ at frequencies f₂ and f₃.

As can be seen, this exemplary embodiment of the present invention communicates the same data to mobile units 601 and 602 while only using one fourth of the resource block. This is due to an improvement in the data rate, in the exemplary embodiment by a factor of four. Utilizing the present invention in the exemplary embodiment provides a great increase in throughput. It should be understood that the time slots and frequencies are only one embodiment of the present invention, and that the idea of the present invention can be utilized with other numbers of frequencies and other number of time slots while still increasing the amount of data that can be transmitted while concurrently improving the frequency reuse among adjacent cells while minimizing or eliminating the effects of intercell interference.

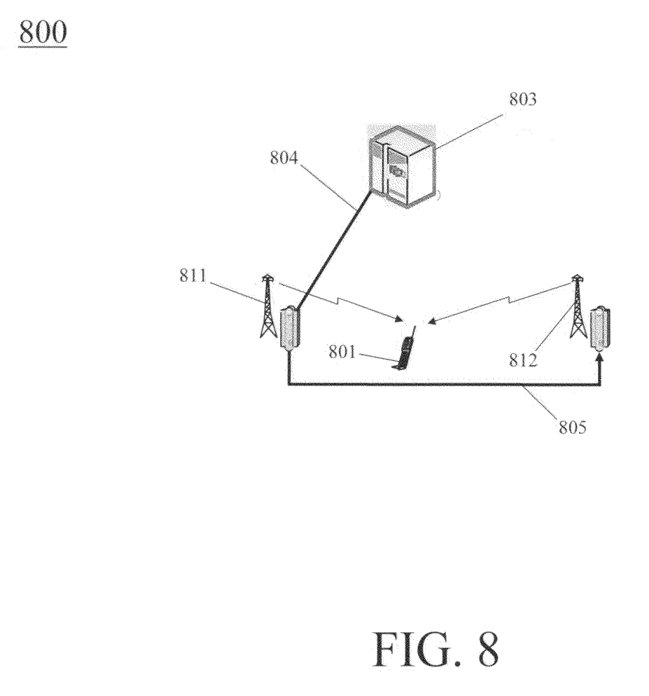

FIG. 8 depicts a portion 800 of a communication system utilizing an exemplary embodiment of the present invention. Portion 800 includes user equipment 801, serving base station 811, helping base station 812, and EPC 803.

EPC 803 preferably comprises an MME and an S/P Gateway. EPC 803 is connected to base station 811 via link 804. Link 804 preferably utilizes an S1 interface.

The synchronization between serving base station 811 and helping base station 812 for downlink resource blocks is link 805. Link 805 is preferably an X2-interface. Serving base station 811 preferably utilizes the SYNC protocol that is introduced as part of the GTP-U in supporting eMBMS services. The GTP-U is the protocol used on top of UDP/IP (IP transport) for carrying user plane protocol data units (PDUs). The SYNC information added to GTP-U is utilized to synchronize data used to generate a certain radio frames. The SYNC protocol provides information related to transmission timing and means to detect and recover packet loss.

In accordance with an exemplary embodiment, one radio frame has ten sub-frames and each sub-frames has two slots. Serving base station 811 sends the user plane PDUs to helping base station 812. Helping base station 812 buffers the packets and waits for the transmission timing indicated by the SYNC protocol.

Utilizing this exemplary embodiment, UE 801 receives identical signals from both base station 811 and base station 812 and combines the signals.

In one exemplary embodiment of the present invention, the MCH (multicast channel) is used as the transport channel. The serving base station schedules the MCH and the MCH is mapped to the PMCH (physical multicast channels) that utilizes the radio frames specified.

It should be noted that, although two cells from two eNodeBs are used in this exemplary embodiment, the present invention works for cells from the same eNodeB as well. In such a configuration, the eNodeB handles data transmission for both cells rather than utilizing the X2-interface.

While this invention has been described in terms of certain examples thereof, it is not intended that it be limited to the above description, but rather only to the extent set forth in the claims that follow.

I claim:

1. A method, the method comprising:
determining that a mobile unit is receiving signals from a first cell and a second cell;
receiving data to be sent to the mobile unit by the first cell;
sending the data to the second cell by the first cell;
allocating identical downlink resource blocks at the first cell and the second cell; and
concurrently transmitting the signal from the first cell and the second cell.

2. A method in accordance with claim 1, wherein the first cell and the second cell are adjacent.

3. A method in accordance with claim 1, wherein the downlink resource blocks comprise a first portion and second portion, and wherein the step of allocating identical downlink resource blocks at the first cell and the second cell comprises allocating the first portion of the downlink resource blocks for transmitting to the mobile unit.

4. A method in accordance with claim 1, wherein the mobile unit receives the signal from the first cell and the second cell concurrently.

5. A method in accordance with claim 4, further comprising the step of combining the signal from the first cell with the signal from the second cell at the mobile unit.

6. A method in accordance with claim 1, wherein the step of sending the data to the second cell by the first cell comprises sending the data over an X2 interface.

7. A method in accordance with claim 1, wherein the step of concurrently transmitting the signal from the first cell and the second cell comprises:
buffering the data at the second cell; and
transmitting the data from the second cell based on a synchronization timing provided by the first cell.

8. A communication system comprising:
an EPC comprising an MME and an S/P Gateway;
a first base station connected to the EPC via a first link utilizing an S1 interface; and
a second base station coupled to the first base station via a second link utilizing an X2 interface.

9. A communication system in accordance with claim 8, wherein the first base station utilizes a synchronization protocol when sending data to the second base station over the second link.

10. A communication system in accordance with claim 9, wherein the synchronization protocol comprises the SYNC protocol.

11. A communication system in accordance with claim 9, wherein the first base station utilizes the multicast channel to synchronize the data with the second base station.

12. A communication system in accordance with claim 8, the method further comprising the step of adding synchronizing data to data sent from the first base station to the second base station over the second link.

13. A communication system in accordance with claim 8, wherein the second base station buffers the data received from the first base station over the second link.

14. A communication system in accordance with claim 13, wherein the second base station transmits the buffered data based on a received synchronization signal from the first base station.

15. A communication system in accordance with claim 8, wherein the first base station and the second base station can be cells hosted by an eNB.
